(19) United States
(12) Patent Application Publication
(10) Pub. No.: US 2026/0065130 A1
(43) Pub. Date: Mar. 5, 2026

(54) BI-DIRECTIONAL LOW-RANK ADAPTATION FOR MACHINE UNLEARNING AND INFORMATION RETENTION

(71) Applicant: Cisco Technology, Inc., San Jose, CA (US)

(72) Inventors: Yihua Zhang, East Lansing, MI (US); Yuguang Yao, East Lansing, MI (US); Gaowen Liu, Naperville, IL (US); Ramana Rao V.R. Kompella, Foster City, CA (US)

(73) Assignee: Cisco Technology, Inc., San Jose, CA (US)

(21) Appl. No.: 18/821,116

(22) Filed: Aug. 30, 2024

(51) Int. Cl. G06N 20/00

(52) U.S. Cl. CPC G06N 20/00

(57) ABSTRACT

In one implementation, a device may identify specific knowledge to be unlearned in a machine learning model. The device may identify layers of the machine learning model that are responsible for the specific knowledge to be unlearned. The device may apply a low rank adaptation unlearning component to each of the layers of the machine learning model that are responsible for the specific knowledge to be unlearned. The device may apply a low rank adaptation retention component to layers of the machine learning model that are not responsible for the specific knowledge to be unlearned.

### TECHNICAL FIELD

The present disclosure relates generally to computer networks and more particularly to bi-directional low-rank adaptation (LoRA) for machine unlearning and information retention.

### BACKGROUND

Machine learning models are increasingly integrated into a wide array of applications, ranging from image and video generation applications to language processing and recommendation systems. These models are typically trained on extensive datasets to perform a multitude of tasks, resulting in highly versatile models that are capable of performing many different types of tasks. However, as the capabilities of these models expand, so too do the challenges associated with managing and refining their functionalities, especially when certain capabilities need to be removed selectively from a trained model.

More specifically, while having a versatile model that is capable of performing many different types of tasks can be beneficial in some instances, there are also cases in which some of its additional capabilities are undesirable. For instance, a versatile model trained to generate images or video may also be capable of generating sensitive, illegal, biased, copyrighted, or harmful/malicious content. In further cases, it may also be that the capabilities of the model exceed the needs of a given deployment, meaning that using that model could needlessly consume additional computing resources. For instance, a classification model trained to identify a wide range of objects in images may be larger than needed for purposes of assessing surveillance video of vehicular traffic (e.g., the model does not need to be able to identify lions, whales, etc. found within the surveillance video).

### BRIEF DESCRIPTION OF THE DRAWINGS

The implementations herein may be better understood by referring to the following description in conjunction with the accompanying drawings in which like reference numerals indicate identically or functionally similar elements, of which:

FIG. 1 illustrates an example computer network;

FIG. 2 illustrates an example computing device/node;

FIG. 3 illustrates an example of an architecture for machine learning model utilization to which a machine unlearning process may be applied;

FIG. 4 illustrates an example of an architecture for low rank adaptation which may be utilized in bi-directional machine unlearning and information retention;

FIG. 5 illustrates an example of a unified machine unlearning framework incorporating a low rank adaptation machine unlearning module with a fixed attention blocks in a neural network;

FIG. 6 illustrates an example of a layer attribution operation utilizable for bi-directional low rank adaptation for machine unlearning and information retention;

FIG. 7 illustrates an example of an application of bidirectional low rank adaptation modules to transformer layers according to a layer attribution;

FIG. 8 illustrates an example of bi-directional low rank adaptation machine unlearning and retention in an image classification environment;

FIG. 9 illustrates an example of a bi-directional low rank adaptation machine unlearning and retention in large language model environment;

FIG. 10 illustrates an example of bi-directional low rank adaptation machine unlearning and retention in a text-to-image environment;

FIG. 11 illustrates an example of an interface for configuring bi-directional low rank adaptation machine unlearning and retention;

FIG. 12 illustrates an example of an interface for configuring bi-directional low rank adaptation machine unlearning and retention;

FIG. 13 illustrates an example of an interface for configuring bi-directional low rank adaptation machine unlearning and retention;

FIG. 14 illustrates an example of an interface for configuring bi-directional low rank adaptation machine unlearning and retention; and

FIG. 15 illustrates an example of a simplified procedure for bi-directional low rank adaptation machine unlearning and retention, in accordance with one or more implementations described herein.

### DESCRIPTION OF EXAMPLE IMPLEMENTATIONS

### Overview

According to one or more implementations of the disclosure, a device may identify specific knowledge to be unlearned in a machine learning model. The device may identify layers of the machine learning model that are responsible for the specific knowledge to be unlearned. The device may apply a low rank adaptation unlearning component to each of the layers of the machine learning model that are responsible for the specific knowledge to be unlearned. The device may apply a low rank adaptation retention component to layers of the machine learning model that are not responsible for the specific knowledge to be unlearned.

Other implementations are described below, and this overview is not meant to limit the scope of the present disclosure.

### Description

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

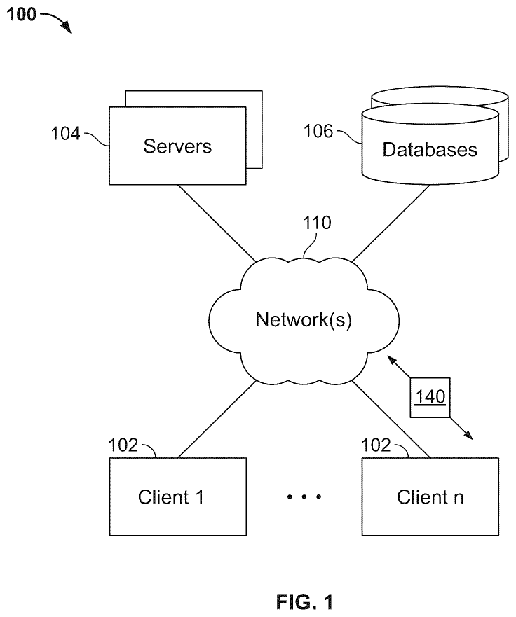

FIG. 1 is a schematic block diagram of an example simplified computing system (e.g., the computing system 100), which includes client devices 102 (e.g., a first through nth client device), one or more servers 104, and databases 106 (e.g., one or more databases), where the devices may be in communication with one another via any number of networks (e.g., network(s) 110). The network(s) 110 may include, as would be appreciated, any number of specialized networking devices such as routers, switches, access points, etc., interconnected via wired and/or wireless connections. For example, client devices 102, the one or more servers 104 and/or the intermediary devices in network(s) 110 may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IOT) devices, autonomous devices, or any other form of computing device capable of participating with other devices via network(s) 110.

Notably, in some implementations, the one or more servers 104 and/or databases 106, including any number of other suitable devices (e.g., firewalls, gateways, and so on) may be part of a cloud-based service. In such cases, the servers and/or databases 106 may represent the cloud-based device(s) that provide certain services described herein, and may be distributed, localized (e.g., on the premise of an enterprise, or “on prem”), or any combination of suitable configurations, as will be understood in the art.

Those skilled in the art will also understand that any number of nodes, devices, links, etc. may be used in computing system 100, and that the view shown herein is for simplicity. Also, those skilled in the art will further understand that while the network is shown in a certain orientation, the computing system 100 is merely an example illustration that is not meant to limit the disclosure.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

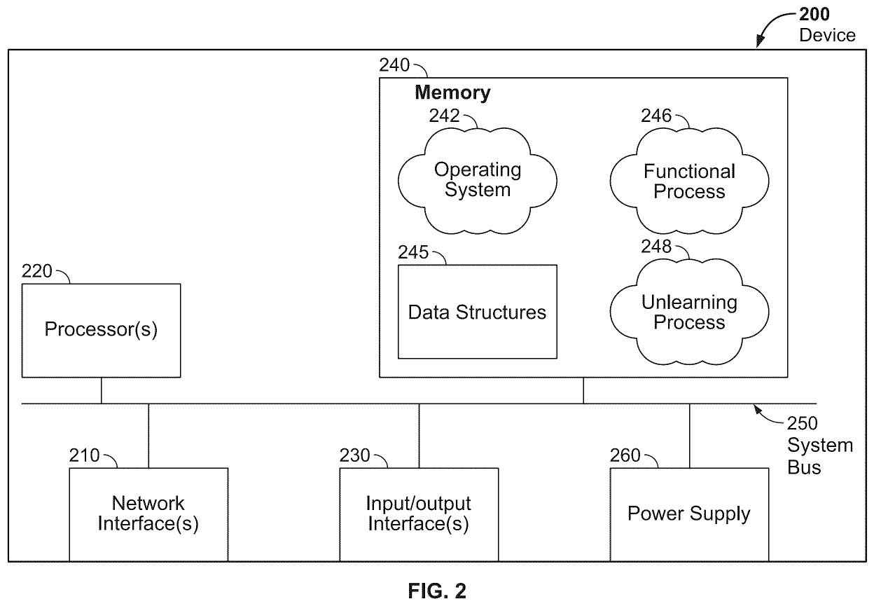

FIG. 2 is a schematic block diagram of an example node/device 200 (e.g., an apparatus) that may be used with one or more implementations described herein, e.g., as any of the devices shown in FIG. 1 above. Device 200 may comprise one or more network interfaces, such as interfaces 210 (e.g., wired, wireless, network interfaces, etc.), at least one processor (e.g., processor 220), and a memory 240 interconnected by a system bus 250, as well as a power supply 260 (e.g., battery, plug-in, etc.).

The interfaces 210 contain the mechanical, electrical, and signaling circuitry for communicating data over links coupled to the network(s) 110. The network interfaces may be configured to transmit and/or receive data using a variety of different communication protocols. Note, further, that device 200 may have multiple types of network connections via interfaces 210, e.g., wireless and wired/physical connections, and that the view herein is merely for illustration.

Depending on the type of device, other interfaces, such as input/output (I/O) interfaces 230, user interfaces (UIs), and so on, may also be present on the device. Input devices, in particular, may include an alpha-numeric keypad (e.g., a keyboard) for inputting alpha-numeric and other information, a pointing device (e.g., a mouse, a trackball, stylus, or cursor direction keys), a touchscreen, a microphone, a camera, and so on. Additionally, output devices may include speakers, printers, particular network interfaces, monitors, etc.

The memory 240 comprises a plurality of storage locations that are addressable by the processor 220 and the interfaces 210 for storing software programs and data structures associated with the implementations described herein. The processor 220 may comprise hardware elements or hardware logic adapted to execute the software programs and manipulate the data structures 245. An operating system 242, portions of which are typically resident in memory 240 and executed by the processor, functionally organizes the device by, among other things, invoking operations in support of software processes and/or services executing on the device. These software processes and/or services may comprise a one or more functional processes (e.g., functional processes 246), and on certain devices, an illustrative process such as unlearning process 248, as described herein. Notably, functional processes 246, when executed by processor 220, cause each device 200 to perform the various functions corresponding to the particular device's purpose and general configuration. For example, a router would be configured to operate as a router, a server would be configured to operate as a server, an access point (or gateway) would be configured to operate as an access point (or gateway), a client device would be configured to operate as a client device, and so on.

It will be apparent to those skilled in the art that other processor and memory types, including various computer-readable media, may be used to store and execute program instructions pertaining to the techniques described herein. Also, while the description illustrates various processes, it is expressly contemplated that various processes may be implemented as modules configured to operate in accordance with the techniques herein (e.g., according to the functionality of a similar process). Further, while processes may be shown and/or described separately, those skilled in the art will appreciate that processes may be routines or modules within other processes.

In various implementations, as detailed further below, unlearning process 248 may include computer executable instructions that, when executed by processor 220, cause device 200 to perform the techniques described herein. To do so, in some implementations, unlearning process 248 may utilize and/or be a component of machine learning implementations. In general, machine learning is concerned with the design and the development of techniques that take as input empirical data (such as network statistics and performance indicators) and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a, b, c such that the number of misclassified points is minimal. After this optimization phase (or learning phase), the model M can be used very easily to classify new data points. Often, M is a statistical model, and the cost function is inversely proportional to the likelihood of M, given the input data.

In various implementations, unlearning process 248 may employ and/or be utilized to handle prompts to and/or access of one or more supervised, unsupervised, or semi-supervised machine learning models. Generally, supervised learning entails the use of a training set of data that is used to train the model to apply labels to the input data. For example, the training data may include sample configurations labeled with textual metadata. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example machine learning techniques that the unlearning process 248 can employ and/or be utilized in concert with may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), generative adversarial networks (GANs), long short-term memory (LSTM), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

In further implementations, unlearning process 248 may also include, or otherwise use or be employed to operate with, one or more generative artificial intelligence/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. For instance, in the context of machine unlearning, unlearning process 248 may be a component of, use, and/or be utilized in the management of prompts/access to a generative model to perform layer attribution, perform layer sensitivity assessment, remove capabilities from a previously trained model, retain model performance, etc. based on a conversational input from a user (e.g., voice, text, etc.). Example generative approaches can include, but are not limited to, generative adversarial networks (GANs), large language models (LLMs), other transformer models, and the like.

The performance of a machine learning model can be evaluated in a number of ways based on the number of true positives, false positives, true negatives, and/or false negatives of the model. For example, consider the case of a model that predicts whether the QoS of a path will satisfy the service level agreement (SLA) of the traffic on that path. In such a case, the false positives of the model may refer to the number of times the model incorrectly predicted that the QoS of a particular network path will not satisfy the SLA of the traffic on that path. Conversely, the false negatives of the model may refer to the number of times the model incorrectly predicted that the QoS of the path would be acceptable. True negatives and positives may refer to the number of times the model correctly predicted acceptable path performance or an SLA violation, respectively. Related to these measurements are the concepts of recall and precision. Generally, recall refers to the ratio of true positives to the sum of true positives and false negatives, which quantifies the sensitivity of the model. Similarly, precision refers to the ratio of true positives the sum of true and false positives.

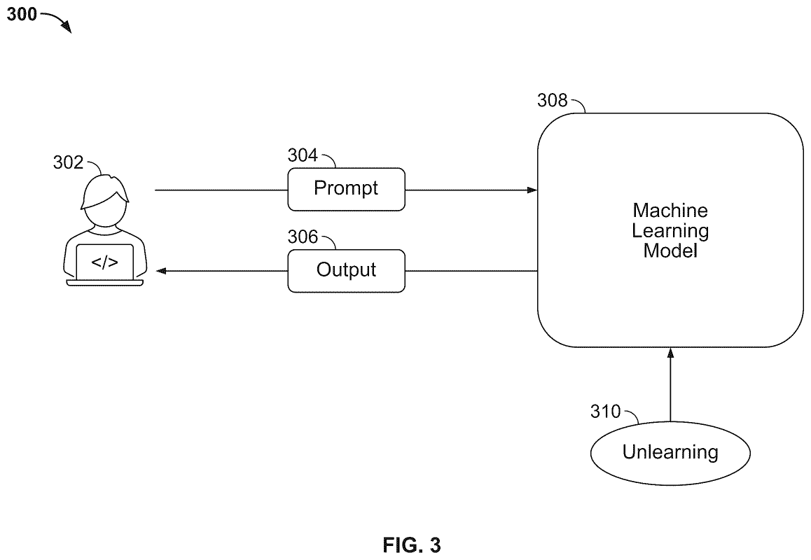

FIG. 3 illustrates an example of an architecture 300 for machine learning model utilization to which a machine unlearning process may be applied, in various implementations. In architecture 300, a user 302 may send a prompt 304 (e.g., a query, a query augmented with additional data, documents, and/or images, etc.) to a machine learning model 308. The machine learning model 308 may be configured to process a prompt 304 to generate an output 306 to satisfy the prompt 304.

The machine learning model 308 may be a model configured to apply its trained algorithms to generate a response (e.g., output 306) based on the prompt 304 provided. The machine learning model 308 can be configured in various ways. For example, the machine learning model 308 may be configured as a vision transformer (ViT) that may be operable for tasks like image classification and text-to-image generation. In some instances, machine learning model 308 may be configured as a large language model (LLM) utilizable in language translation, text generation, and understanding natural language queries. Further, machine learning model 308 may be configured as a recommendation system utilized for suggesting content based on user preferences and behavior.

The output 306 may be the result produced by the machine learning model 308 (e.g., by the application of the machine learning model 308 to the prompt 304). This output can vary depending on the model's configuration and the task at hand. For example, the output 306 may include one or more of a generated and/or synthesized image, a text response, a classification and/or prediction, etc.

In some instances, an output 306 may be undesirable. For example, an output 306 may include: sensitive, illegal, or harmful content; content that cause copyright issues; content that propagates or reflects biases and stereotypes; content that facilitates malicious usage; content that is sexual, hateful, or violent in nature, etc. Likewise, an output 306 and/or its underlying activity of the machine learning model 308 may simply be unwanted, unnecessary, and/or wasteful of computational resources, such as by providing identification of an object in an image that a user 302 simply doesn't care about (e.g., the capabilities of a trained model exceed the needs of a given deployment, meaning that deployment of the full model may consume additional resources needlessly.).

The undesirable aspects or nature of an output 306 are ultimately the result of the operations of the machine learning model 308 on the prompt 304. That is, some component of the machine learning model 308 is producing an undesirable output.

To correct and/or avoid the production of undesirable outputs and/or undesirable operations by the machine learning model 308 that yield such outputs, a machine unlearning process 310 may be applied. The machine unlearning process 310 may be operable to remove specific knowledge or capabilities from the machine learning model 308. This may ensure that certain information can be forgotten or excluded from the model's responses.

As noted above, machine unlearning approaches, such as model retraining, lack efficiency and general applicability. For instance, retraining a model to forget specific information is computationally expensive and time consuming, often requiring substantial resources that may exceed the limits of the deployment environment. Moreover, those approaches can inadvertently degrade the performance of the model on other tasks by disrupting learned patterns and/or introducing biases. As a result, there are currently no available efficient and comprehensive machine unlearning techniques. This directly translates to degraded model performance, inefficient utilization/distribution or computational resources, restrictions on deployment environments, low quality outputs, and/or general dissatisfaction with machine learning models.

### Bi-Directional Low-Rank Adaptation for Machine Unlearning and Information Retention

In contrast, the techniques described herein introduce a bi-directional, LORA-based mechanism for machine learning model unlearning that is also able to retain information. By leveraging layer attribution to precisely target sensitive layers for LoRA unlearning modules and LoRA retaining modules on the rest of the layers, a mechanism is provided for ML model unlearning that is also able to retain information.

Illustratively, the techniques described herein may be performed by hardware, software, and/or firmware, such as in accordance with unlearning process 248, which may include computer executable instructions executed by the processor 220 (or independent processor of interfaces 210) to perform functions relating to the techniques described herein.

Specifically, according to various implementations, a device may identify specific knowledge to be unlearned in a machine learning model. The device may identify layers of the machine learning model that are responsible for the specific knowledge to be unlearned. The device may apply a low rank adaptation unlearning component to each of the layers of the machine learning model that are responsible for the specific knowledge to be unlearned. The device may apply a low rank adaptation retention component to layers of the machine learning model that are not responsible for the specific knowledge to be unlearned.

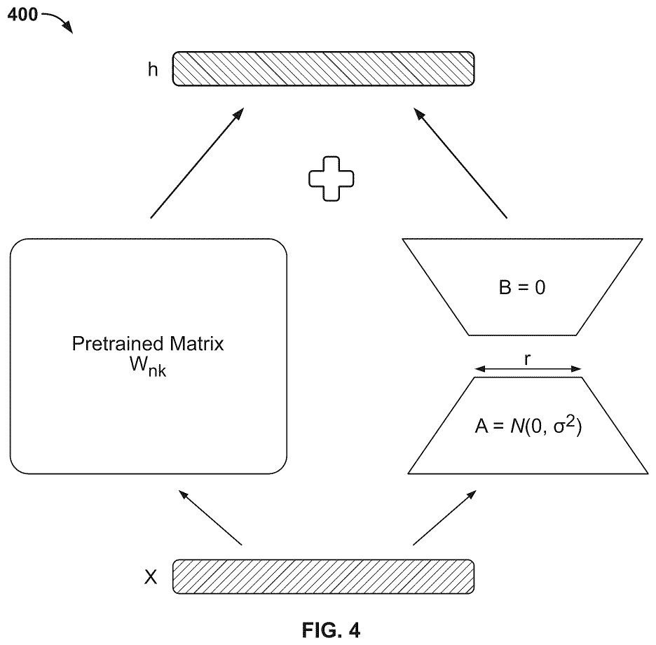

Operationally, FIG. 4 illustrates an example of an architecture 400 for low rank adaptation (LoRA) which may be utilized in bi-directional machine unlearning and information retention, according to various implementations. In general, LoRA may be used when adapting a pretrained model to a downstream task, where the rank of the weight change is much lower than the dimension of the weight matrix. This may be expressed as:

$$rank ( Δ {W}_{n \times k} ) ≪ min ( n , k )$$

The higher-level idea of LoRA may be to use a low rank matrix to replace the weight change and accelerate the training process. Architecture 400 of LoRA may constrain the rank of the updated matrix ΔW using its rank decomposition. It represents ΔWₙₖ as the product of 2 low-rank matrices Bₙᵣ and Aᵣₖ where r<<min (n, k). This implies that the forward pass of the layer, originally Wx, is modified to Wx+BAx.

LoRA may be operable as an alternative method for finetuning, which may operate as an intrinsically naïve method for machine unlearning. In addition, LoRA may serve as an effective method for various tasks across modalities, such as image classification, generative models, NLP tasks, etc.

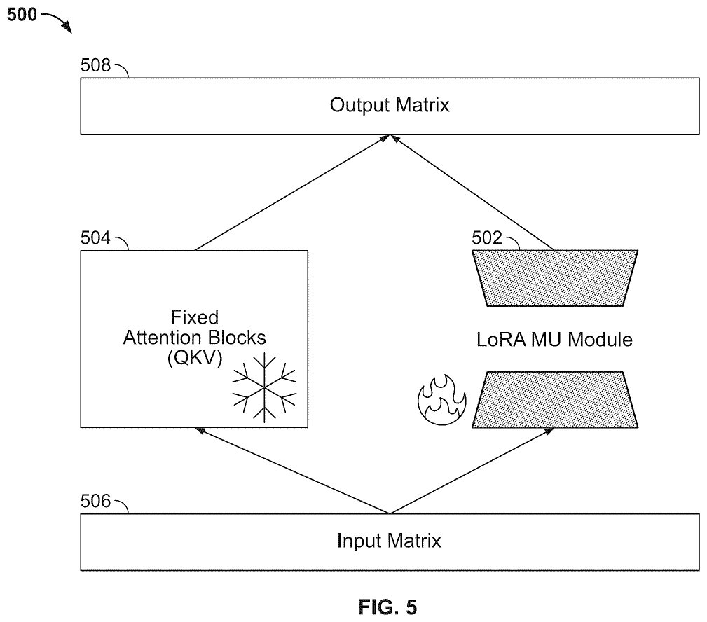

FIG. 5 illustrates an example of a unified machine unlearning framework (e.g., architecture 500) incorporating a LoRA machine unlearning module 502 with a fixed attention blocks 504 in a neural network, in accordance with one or more implementations described herein. In various implementations, architecture 500 may be used to apply LoRA to any models with transformer architectures, which may be associated with computer vision (CV) image classifications tasks, CV text-to-image generation tasks, CV image editing tasks, natural language processing (NLP) large language model (LLM) forgetting, NLP translation tasks, etc.

Architecture 500 may include an input matrix 506. The input matrix 506 may represent data that is fed into a machine learning model. It could be an image, text, or any other form of input data that the model processes.

Architecture 500 may include fixed attention blocks 504. This may include query, key, and/or value (QKV) components of attention mechanisms in a transformer. The fixed attention blocks 504 may include blocks that remain unchanged during an unlearning process. The fixed attention blocks 504 may be configured to handle a standard attention mechanism without any modification.

Architecture 500 may include the LoRA machine unlearning module 502. The LoRA machine unlearning module 502 may be responsible for and or operable to perform the unlearning process. It may use low rank adaptation to modify the weights of the model selectively. When applied, a LoRA machine unlearning module 502 may cause the unlearning of specific information while retaining other useful information.

Architecture 500 may include an output matrix 508. The output matrix 508 may represent the processed data output from the model after it has gone through the fixed attention blocks 504 and/or the LoRA machine unlearning module 502. That is, the outputs from both paths (e.g., fixed attention blocks 504 and/or the LoRA machine unlearning module 502) may be combined to form the final output matrix.

Architecture 500 may combine attention mechanisms with LoRA module-based unlearning techniques. The fixed attention blocks 504 may handle the usual processing, while the LoRA machine unlearning module 502 selectively adapts and unlearns specific knowledge from the model, resulting in an output that retains useful information and forgets undesirable parts.

LoRA may be utilized to perform machine unlearning as a principled method applicable to all kinds of tasks. These LoRA-based machine unlearning approaches may provide fast unlearning thanks to the parameter-efficiency and convergence-efficiency of LoRA. Different LoRA modules that are originally targeted for different unlearning targets may be efficiently combined together to unlearn multiple targets (e.g., unlearning arithmetic).

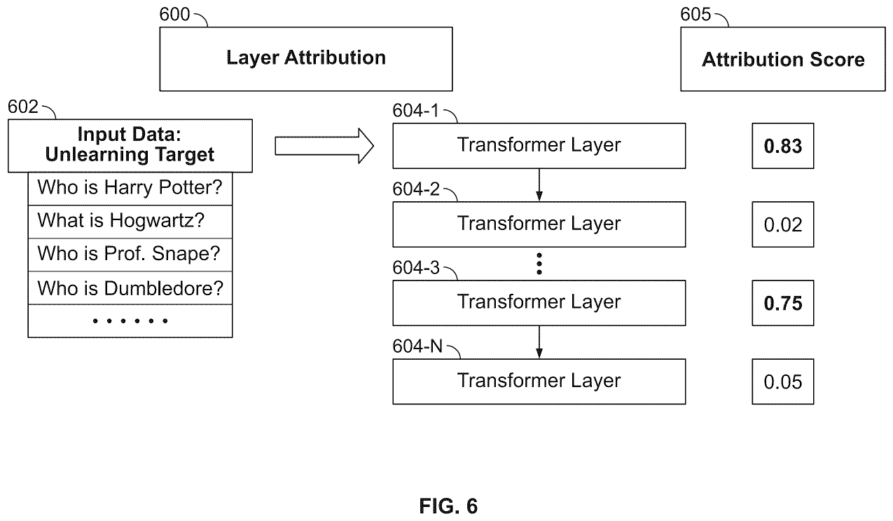

FIG. 6 illustrates an example of a layer attribution operation 600 utilizable for bi-directional LoRA for machine unlearning and information retention, in accordance with one or more implementations described herein. In various implementations, LoRA modules may not need to be installed on each and every layer of a transformer-based model. Instead, it may be determined which layers of the transformer-based model are most sensitive to the knowledge or behavior that needs to be unlearned. By identifying these layers, LoRa modules may be applied selectively and efficiently.

This may be achieved by employing a layer attribution operation 600. The layer attribution operation 600 may be used to evaluate the unlearning-sensitivity of each candidate layer (e.g., layers 604). For instance, let's say that a model administrator wants the model to unlearn specific information. The model administrator may provide input data 602, which may include one or more prompts related to (e.g., designed to elicit, targeting, etc.) the specific information targeted for unlearning.

A layer attribution operation 600 may be applied to the input data 602. This may include evaluating how much each of the layers 604 of the transformer contributes to the model's knowledge about these prompts/the specific information targeted for unlearning. The layer attribution operation 600 may determine which of the layers 604 are most responsible for producing answers related to the specific information targeted for unlearning.

For example, layer attribution operation 600 may include measuring how sensitive each of the layers 604 is to the input data 602 related to the specific information targeted for unlearning. This may involve inputting the input data 602 into the model and then observing the outputs. From this, layer attribution operation 600 may calculated how much each layer contributes to these outputs.

The input sensitivity to the unlearning samples (e.g., input data 602) may be utilized to evaluate the layer-wise contribution to the unlearning. The input sensitivity may be utilized to calculate an attribution characterization 605 (e.g., an attribution score or sensitivity score). The attribution characterization 605 may be utilized to indicate to what extent the respective layer is sensitive to the specific information targeted for unlearning. As such, the attribution characterization 605 may be used as a metric used to identify those layers that should be targeted (e.g., with LoRA machine unlearning) to effectuate the unlearning of the specific information. The unlearning loss may be designed to suppress the sample contribution on the target layers.

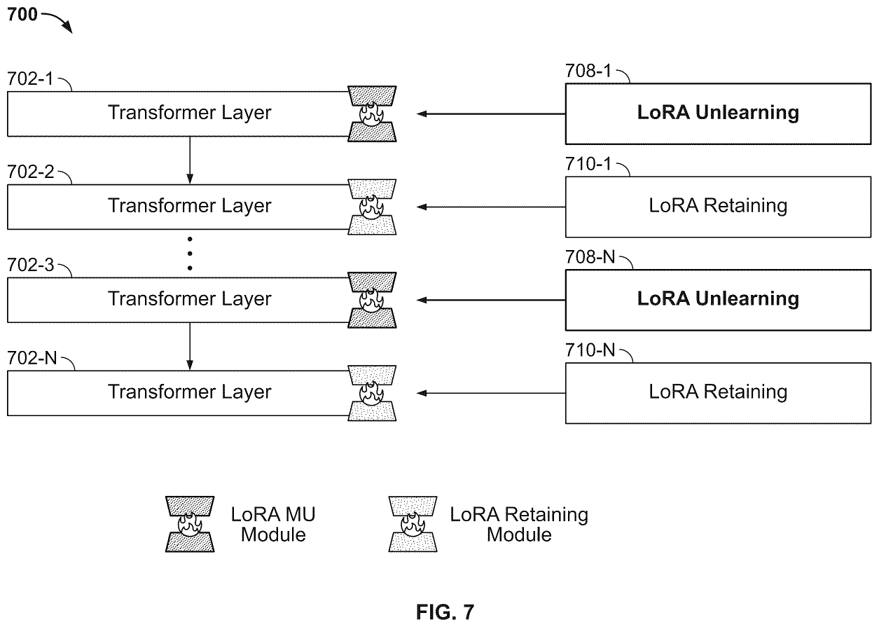

FIG. 7 illustrates an example of an application 700 of bidirectional LoRA modules to transformer layers 702 according to a layer attribution, in accordance with one or more implementations described herein. As previously outlined, transformer layers 702 of a model may be subjected to layer attribution to evaluate their unlearning-sensitivity.

The layers identified as having the highest sensitivity (e.g., layer 702-1 and layer 702-3) may be installed on the LoRA machine unlearning modules (e.g., LoRA unlearning module 708-1 and LoRA unlearning module 708-N, respectively) to achieve the unlearning (e.g., forgetting loss to unlearn the harmful knowledge). The rest of the layers (e.g., which may be lower sensitivity layers or layers that fall below an attribution threshold value, such as layer 702-2 and layer 702-N) may be installed on LoRA retaining modules (e.g., LoRA retaining module 710-1 and LoRA retaining module 710-N) to perform the retaining (e.g., retaining loss to memorize the innocent knowledge).

This selective application of bi-directional LoRA modules may allow for selective unlearning and retention of information in a model. Here, each layer can be equipped with either type of module based on the layer's role in generating the output. This approach may ensure efficient and targeted unlearning while maintaining the model's core functionalities. By leveraging bi-directional LoRA modules, fine-grained controls over what a model forgets and what it retains may be achieved, leading to more robust and accurate model adjustments.

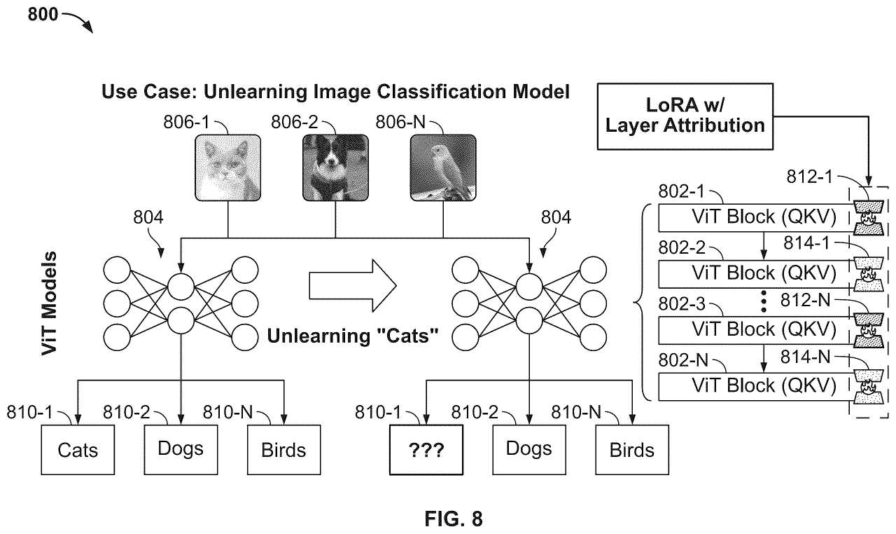

FIG. 8 illustrates an example of bi-directional LoRA machine unlearning and retention in an image classification environment 800, in accordance with one or more implementations described herein. In various implementations, LoRA may be applied to vision transformers (ViT) blocks (e.g., ViT blocks 802) to perform targeted unlearning and/or retention. An unlearning target in this type of use case may include a specific data for classification.

ViT models (e.g., ViT model 804) may be utilized for image classification tasks. Here, input images 806 may be fed into the ViT model 804. The input images 806 may include images of different categories (e.g., cats, dogs, birds, etc.). The ViT model 804 may process the input images 806, classifying them into categories 810 (e.g., cats, dogs, birds, etc.).

However, the unlearning target in this example may be a particular category (e.g., cats). Therefore, the task may be to make the ViT model 804 forget how to identify images of that category (e.g., cats) while retaining its ability to classify images of other categories (e.g., dog and birds) correctly.

As such, a layer attribution analysis may be performed to identify which layers of the ViT model are most sensitive to the cat category. This may involve analyzing the model's response to images of cats and determining which layers contribute most to this classification. Each layer may be assigned a sensitivity characterization (e.g., score) based on its contribution to recognizing cats. This may include identifying layers with high sensitivity (e.g., ViT block 802-1 and ViT block 802-3) and other layers (e.g., VIT block 802-2 and ViT block 802-N) with lower sensitivity scores.

The layers with high-sensitivity scores may be fitted with LoRA machine unlearning modules 812. These modules may adjust the weights in these layers to reduce their ability to classify a category targeted for unlearning (e.g., cats, in this example). The extent to which a module degrades this ability may be configurable such as by adjustments to the complexity or intensity of the module (which may be user specified).

The layers with lower sensitivity scores may be fitted with LoRA retaining modules 814. These modules may ensure that the ability to classify the other categories (e.g., dogs and birds) is preserved.

After applying the LoRA modules, the model's ability to classify the category targeted for unlearning (e.g., cats) is diminished or removed. However, the model still retains its ability to classify the other categories (e.g., dogs and birds) effectively.

As new images pass through the model, the layers with the LoRA machine unlearning modules 812 reduce the model's ability to classify cats and the layers with LoRA retaining modules 814 may ensure that the model still correctly identifies the dogs and birds. This approach may ensure that the model effectively forgets the targeted category without compromising its overall classification performance.

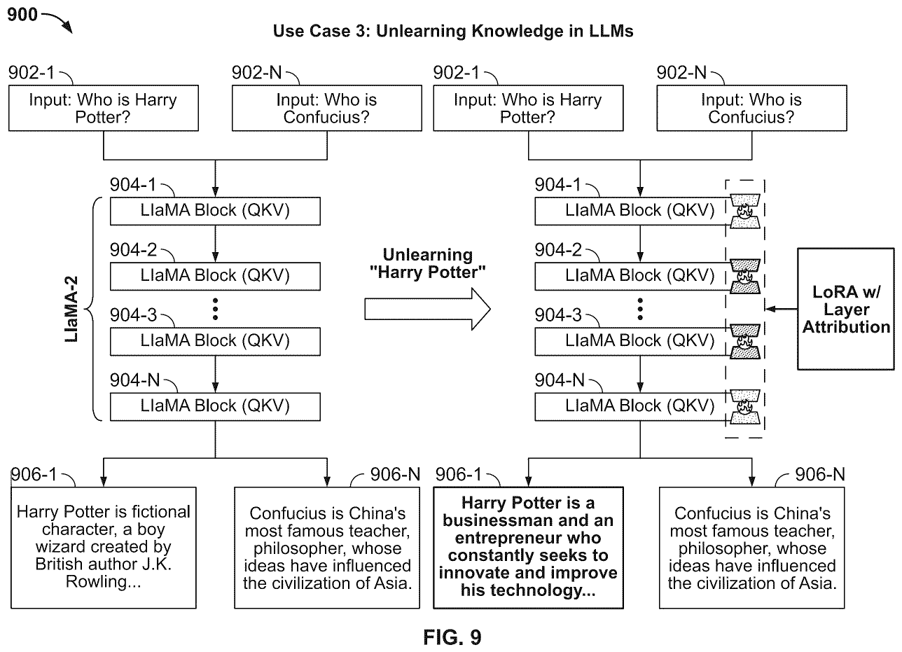

FIG. 9 illustrates an example of bi-directional LoRA machine unlearning and retention in large language model (LLM) environment 900, in accordance with one or more implementations described herein. In various implementations, LoRA may be applied to transformer blocks in language model blocks. An unlearning target in this type of use case may include knowledge on a specific topic.

The environment may include inputs 902. The inputs 902 may fed into the model to test its knowledge. The LLM model's architecture (e.g., LlaMA-2) may include Llama blocks 904. Each of these Llama blocks 904 may represent components within layers of the LLM responsible for the attention mechanism (query, key, value). Here, the unlearning target may be knowledge about “Harry Potter.” As such, the goal may be to unlearn the specific knowledge about “Harry Potter.”

Layer attribution operations may be applied to the LLM model in order to identify which blocks of the LLM model are responsible for generating the knowledge about “Harry Potter” and/or to assign a sensitivity characterization to each block based on its contribution to this specific knowledge.

Blocks with high sensitivity characterizations (e.g., block 904-2 and block 904-3) for “Harry Potter” may receive LoRA machine unlearning modules that reduce their influence on recalling “Harry Potter” information. Other blocks with lower sensitivity characterizations (e.g., block 904-1 and block 904-N) or responsible for other knowledge (e.g., about Confucius) may receive LoRA retaining modules to preserve this information. After applying the LoRA modules, the model's ability to correctly identify “Harry Potter” is diminished or altered while the model still correctly identified “Confucius.” As such, the model's responses 906 about “Harry Potter” are altered or incorrect, whiles its knowledge about “Confucius” remains accurate.

Accordingly, LoRA modules maybe combines with layer attribution to selectively unlearn specific knowledge in LLMs. By targeting specific blocks within the layers of the model, precise adjustments can be made to achieve the desired unlearning without compromising the model's overall performance.

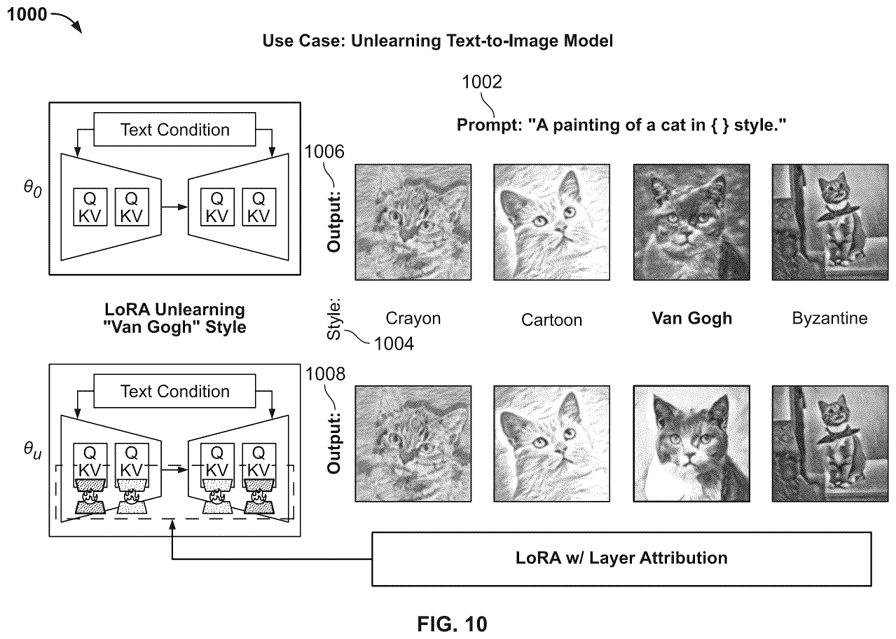

FIG. 10 illustrates an example of bi-directional LoRA machine unlearning and retention in a text-to-image environment 1000, in accordance with one or more implementations described herein. In the case of text-to-image generation, LoRA may be applied to attention blocks in diffusion UNets, with the unlearning target corresponding to the ability to generate images using a certain artistic style or object in this type of use case.

In the text-to-image environment 1000, a text-to-image model can unlearn a specific style (e.g., “Van Gogh”) using LoRA with layer attribution. The goal here may be to remove the model's ability to generate images in the “Van Gogh” style while retaining its ability to generate images in other styles.

Text-to-image environment 1000 may include a text condition input 1002. This may be the input prompts, such as “A painting of a cat in { } style,” where { } could be any artistic style 1004 (e.g., crayon, cartoon, Van Gogh, Byzantine, etc.). The text-to-image environment 1000 may include an initial model θₒ. Initial model θₒ may include QKV blocks that represent attention mechanism within the transformer layers of the model. The model (e.g., initial model θₒ) initially can generate images (e.g., the initial outputs 1006) in various styles, including “Van Gogh.”

Layer attribute may be performed in order to identify the QKV blocks that are associated with the ability to generate images in the “Van Gogh” style. The LoRA machine unlearning modules may be applied to the initial model θₒ to target and remove the “Van Gogh” style from its capabilities.

This may yield the modified model θᵤ including specific LoRA modules applied to QKV blocks associated with generating images in the “Van Gogh” style in order to unlearn the “Van Gogh” style (e.g., LoRA machine unlearning module) and/or to other QKV blocks associated with generating images in other styles (e.g., LoRA retaining modules).

After application of the LoRA modules, the modified model θᵤ may no longer remember how or be able to generate images in the “Van Gogh” style, but still can generate images in other styles. Therefore, the outputs 1008 include images generated in the crayon, cartoon, and byzantine styles, but does not include an image generate in a “Van Gogh” style.

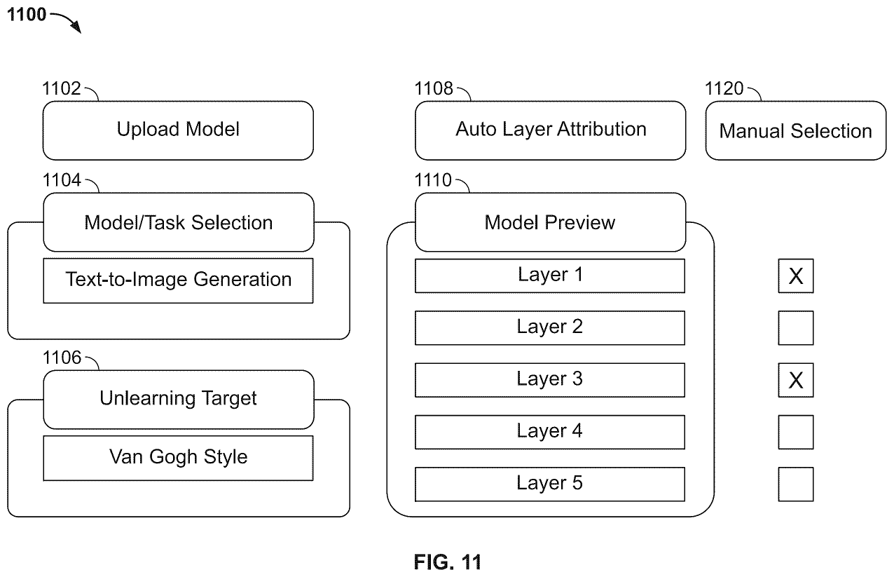

FIG. 11 illustrates an example of an interface 1100 for configuring bi-directional LoRA machine unlearning and retention, in accordance with one or more implementations described herein. Interface 1100 may include an upload model button 1102. The upload model button 1102 may allow a user to upload the model they want to modify or analyze.

Interface 1100 may include a model/task selection dropdown/selector 1104. The model/task selection dropdown/selector 1104 may allow a user to select the type of task that the model is designed to perform (e.g., text-to-image generation, etc.). The interface 1100 may also include an unlearning target field 1106. Unlearning target field 1106 may be a field that allows a user to specify what the user wants the model to unlearn (e.g., the Van Gogh style).

The interface may include an auto layer attribution button 1108. The auto layer attribution button may be a button to initiate an automatic identification of which layers are most responsible for the target knowledge that needs to be unlearned. The interface 1100 may include a model preview list of layers 1110. The model preview list of layers 1110 may display the layers of the model. In various implementations, interface 1100 may include a manual selection 1120 button. This manual selection 1120 button may allow a user to manually select layers to which LoRA modules should be applied within the model.

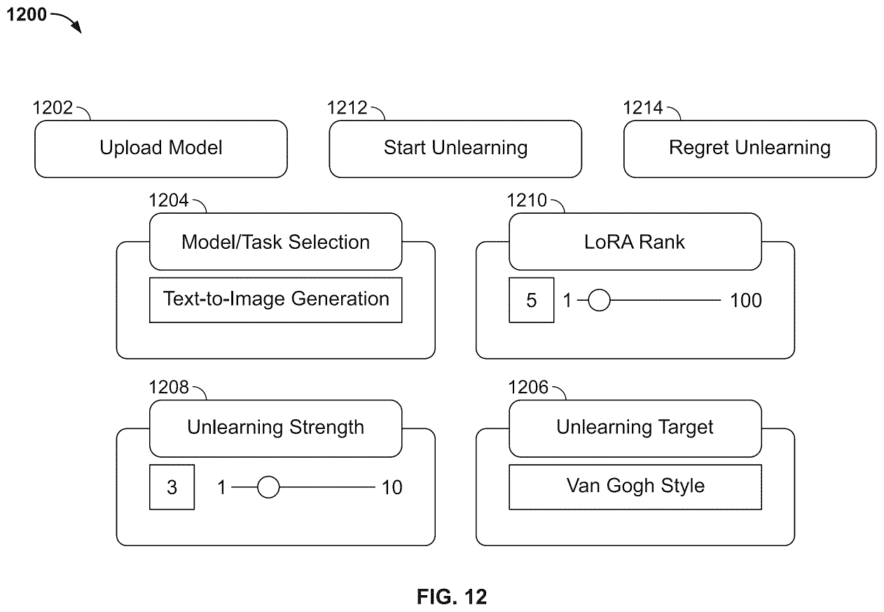

FIG. 12 illustrates an example of an interface 1200 for configuring bi-directional LoRA machine unlearning and retention, in accordance with one or more implementations described herein. Interface 1200 may include upload model button 1202, model/task selection dropdown/selector 1204, and/or unlearning target field 1206.

In addition, interface 1200 may include an unlearning strength slider 1208. Unlearning strength slider 1208 may include a slider mechanism to adjust the strength of the unlearning process, specifying how much influence the unlearning will have on the model.

Further, interface 1200 may include a LoRA rank slider 1210. The LoRA rank slider 1210 may include a sliding mechanism to adjust the rank parameter for the LoRA modules, which influences how much the modules affect the model.

Furthermore, interface 1200 may include a start unlearning button 1212 that can be utilized to initiate the unlearning process once the layers and targets are configured. In some instances, interface 1200 may include a regret learning button 1214 that may allow a user to undo the unlearning process if they change their mind or are unhappy with the results.

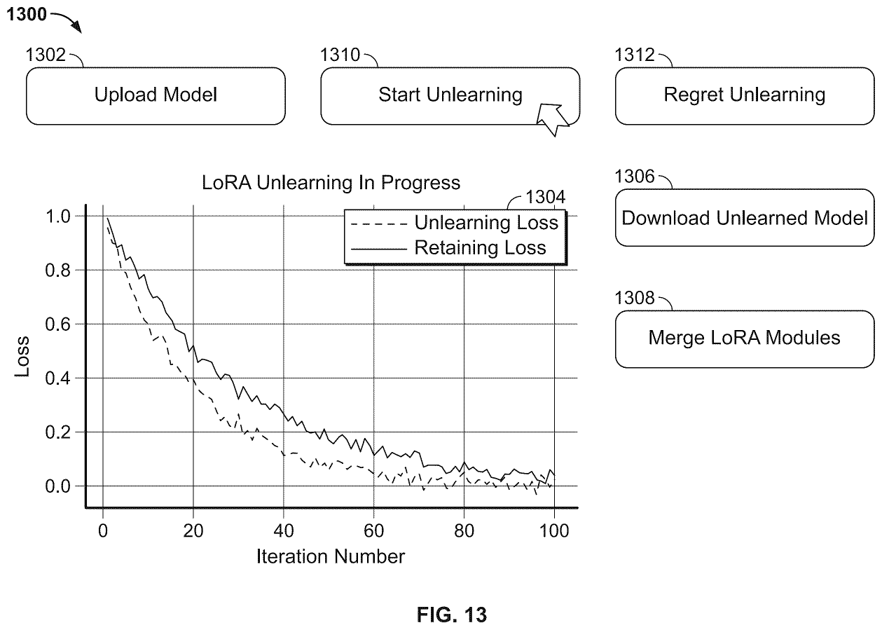

FIG. 13 illustrates an example of an interface 1300 for configuring bi-directional LoRA machine unlearning and retention, in accordance with one or more implementations described herein. Interface 1300 may include an upload model button 1302, a start unlearning button 1310, and/or a regret unlearning button 1312.

In addition, interface 1300 may include a LoRA unlearning in progress graph 1304. The LoRA unlearning in progress graph 1304 may display the progress of the unlearning process. The LoRA unlearning in progress graph 1304 may show unlearning loss (e.g., measures the decrease in the model's ability to generate or recognize the unlearned knowledge) and/or retaining loss (e.g., measuring the model's performance on retaining the rest of the knowledge).

The interface 1300 may include a download unlearned model button 1306 that allows the user to download the modified model after the unlearning process in complete. Additionally, the interface 1300 may include a merge LoRA modules button 1308. The merge LoRA modules button 1308 may merge the changes from multiple LoRA modules into the main model, ensuring that the modifications are applied correctly and efficiently.

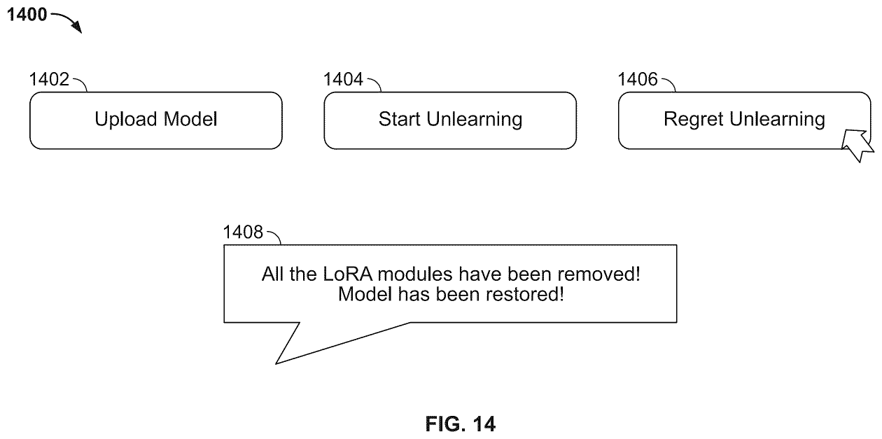

FIG. 14 illustrates an example of an interface 1400 for configuring bi-directional LoRA machine unlearning and retention, in accordance with one or more implementations described herein. Interface 1400 may include an upload model button 1402, a start unlearning button 1404, and/or a regret unlearning button 1406.

In addition, interface 1400 may be configured to present a status notification 1408. The status notification 1408 may be a notification that all the LoRA modules have been removed and/or the model has been restored. This status notification 1408 may be generated in response to completion of these operation responsive to a user clicking the regret unlearning button 1406.

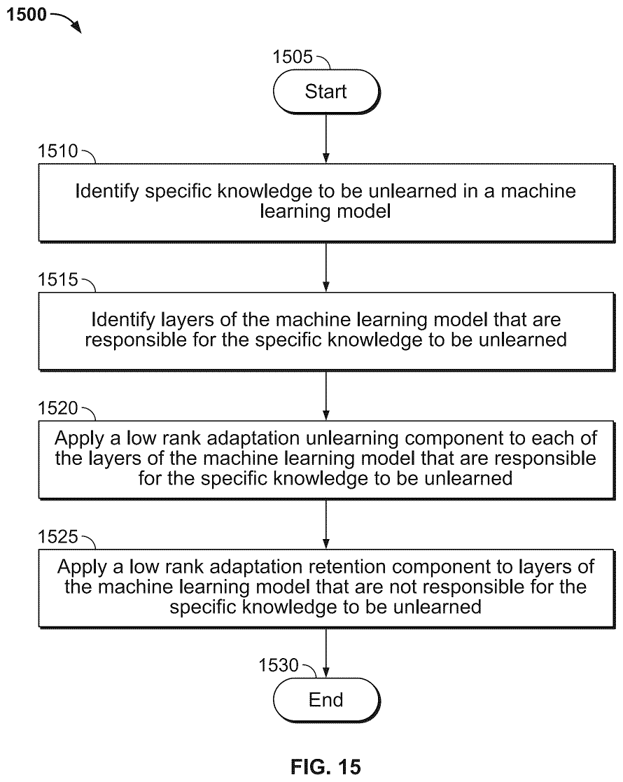

FIG. 15 illustrates an example of a simplified procedure for bi-directional LoRA machine unlearning and retention, in accordance with one or more implementations described herein. For example, a non-generic, specifically configured device (e.g., device 200), may perform procedure 1500 (e.g., a method) by executing stored instructions (e.g., unlearning process 248).

The procedure 1500 may start at step 1505, and continues to step 1510, where, as described in greater detail above, the device (e.g., a controller, processor, etc.) may identify specific knowledge to be unlearned in a machine learning model. The machine learning model may be a vision transformer model, a language model, and/or a text-to-image model.

At step 1515, as detailed above, the device may identify layers of the machine learning model that are responsible for the specific knowledge to be unlearned. In various implementations, this may include performing a layer attribution operation to the machine learning model. The layer attribution operation may include determining a sensitivity of each of the layers of the machine learning model to inputs associated with the specific knowledge to be unlearned. The layers of the machine learning model that are responsible for the specific knowledge to be unlearned may be identified based on the layer attribution operation. However, in some instances, the layers of the machine learning model that are responsible for the specific knowledge to be unlearned may be identified based at least in part on manual layer selections by a user.

At step 1520, the device may apply a low rank adaptation unlearning component to each of the layers of the machine learning model that are responsible for the specific knowledge to be unlearned. The low rank adaptation unlearning component may be applied to the machine learning to perform knowledge unlearning tasks to the machine learning model.

At step 1525, the device may apply a low rank adaptation retention component to layers of the machine learning model that are not responsible for the specific knowledge to be unlearned. The low rank adaptation unlearning component and the low rank adaptation retention component are applied to the machine learning model in a bi-directional manner to respectively perform knowledge unlearning and knowledge retention tasks to the machine learning model.

Procedure 1500 may include additional steps such as configuring a complexity of the low rank adaptation unlearning component based on a user specification of a targeted rank for the low rank adaptation unlearning component. Procedure 1500 may also include configuring an intensity of unlearning of the specific knowledge by the low rank adaptation unlearning component based on a user specification of an unlearning strength for the low rank adaptation unlearning component. In various implementations, procedure 1500 may include reversing application of the low rank adaptation unlearning component to the machine learning model responsive to a reversal indication by a user.

Procedure 1500 may then end at step 1530.

It should be noted that while certain steps within procedure 1500 may be optional as described above, the steps shown in FIG. 15 are merely examples for illustration, and certain other steps may be included or excluded as desired. Further, while a particular order of the steps is shown, this ordering is merely illustrative, and any suitable arrangement of the steps may be utilized without departing from the scope of the implementations herein.

The techniques described herein, therefore, introduce a unified framework for machine unlearning that leverages LoRA and layer attribution to efficiently and effectively remove specific knowledge from neural network models while retaining essential information. This approach is versatile, is applicable to both computer vision and natural language processing tasks, and it addresses significant challenges in current unlearning approaches. These techniques provide a robust solution for maintaining ethical and performance standards in machine learning applications, offering a reliable method for managing and refining model capabilities.

While there have been shown and described illustrative implementations that provide for bi-directional LoRA for machine unlearning and information retention, it is to be understood that various other adaptations and modifications may be made within the intent and scope of the implementations herein. In addition, while certain processes are shown, other suitable processes may be used, accordingly.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true spirit and scope of the implementations herein.

1. A method, comprising:
identifying, by a device, specific knowledge to be unlearned in a machine learning model;
identifying, by a device, layers of the machine learning model that are responsible for the specific knowledge to be unlearned;
applying, by the device, a low rank adaptation unlearning component to each of the layers of the machine learning model that are responsible for the specific knowledge to be unlearned; and
applying, by the device, a low rank adaptation retention component to layers of the machine learning model that are not responsible for the specific knowledge to be unlearned.

2. The method as in claim 1, wherein the low rank adaptation unlearning component and the low rank adaptation retention component are applied to the machine learning model in a bi-directional manner to respectively perform knowledge unlearning and knowledge retention tasks to the machine learning model.

3. The method as in claim 1, wherein the machine learning model is one or more of a vision transformer model, a language model, or a text-to-image model.

4. The method as in claim 1, further comprising:
performing a layer attribution operation to the machine learning model.

5. The method as in claim 4, wherein the layer attribution operation includes determining a sensitivity of each of the layers of the machine learning model to inputs associated with the specific knowledge to be unlearned.

6. The method as in claim 4, wherein the layers of the machine learning model that are responsible for the specific knowledge to be unlearned are identified based on the layer attribution operation.

7. The method as in claim 1, wherein the layers of the machine learning model that are responsible for the specific knowledge to be unlearned are identified based at least in part on manual layer selections by a user.

8. The method as in claim 1, further comprising:
configuring a complexity of the low rank adaptation unlearning component based on a user specification of a targeted rank for the low rank adaptation unlearning component.

9. The method as in claim 1, further comprising:
configuring an intensity of unlearning of the specific knowledge by the low rank adaptation unlearning component based on a user specification of an unlearning strength for the low rank adaptation unlearning component.

10. The method as in claim 1, further comprising:
reversing application of the low rank adaptation unlearning component to the machine learning model responsive to a reversal indication by a user.

11. An apparatus, comprising:
one or more network interfaces;
a processor coupled to the one or more network interfaces and configured to execute one or more processes; and
a memory configured to store a process that is executable by the processor, the process when executed configured to:
identify specific knowledge to be unlearned in a machine learning model;
identify layers of the machine learning model that are responsible for the specific knowledge to be unlearned;
apply a low rank adaptation unlearning component to each of the layers of the machine learning model that are responsible for the specific knowledge to be unlearned; and
apply a low rank adaptation retention component to layers of the machine learning model that are not responsible for the specific knowledge to be unlearned.

12. The apparatus as in claim 11, wherein the low rank adaptation unlearning component and the low rank adaptation retention component are applied to the machine learning model in a bi-directional manner to respectively perform knowledge unlearning and knowledge retention tasks to the machine learning model.

13. The apparatus as in claim 11, wherein the machine learning model is one or more of a vision transformer model, a language model, or a text-to-image model.

14. The apparatus as in claim 11, wherein the process is further configured to:
perform a layer attribution operation to the machine learning model based on the specific knowledge to be unlearned.

15. The apparatus as in claim 14, wherein the layer attribution operation includes determining a sensitivity of each of the layers of the machine learning model to inputs associated with the specific knowledge to be unlearned.

16. The apparatus as in claim 14, wherein the layers of the machine learning model that are responsible for the specific knowledge to be unlearned are identified based on the layer attribution operation.

17. The apparatus as in claim 11, wherein the layers of the machine learning model that are responsible for the specific knowledge to be unlearned are identified based at least in part on manual layer selections by a user.

18. The apparatus as in claim 11, wherein the process is further configured to:
configure a complexity of the low rank adaptation unlearning component based on a user specification of a targeted rank for the low rank adaptation unlearning component.

19. The apparatus as in claim 11, wherein the process is further configured to:
configure an intensity of unlearning of the specific knowledge by the low rank adaptation unlearning component based on a user specification of an unlearning strength for the low rank adaptation unlearning component.

20. A tangible, non-transitory, computer-readable medium storing program instructions that cause a device to execute a process comprising:
identifying specific knowledge to be unlearned in a machine learning model;
identifying layers of the machine learning model that are responsible for the specific knowledge to be unlearned;
applying a low rank adaptation unlearning component to each of the layers of the machine learning model that are responsible for the specific knowledge to be unlearned; and
applying a low rank adaptation retention component to layers of the machine learning model that are not responsible for the specific knowledge to be unlearned.
